(19) United States
(12) Patent Application Publication
(10) Pub. No.: US 2008/0275755 A1
(43) Pub. Date: Nov. 6, 2008

(54) System for, and method of, providing a sequence of content segments and advertisements to a user and recommending product purchases to the user on the basis of the user's behavioral characteristics

(76) Inventors: Richard C. Brustein, Los Angeles, CA (US); G. Michael Wool, Los Angeles, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/408,579

(22) Filed: Apr. 21, 2006

(51) Int. Cl. G06Q 30/00; G06Q 10/00; G01C 21/00

(52) U.S. Cl. 705/10; 705/14; 701/300

(57) ABSTRACT

A user elects to view specific content segments (e.g., movie). The user transmits this election and his identity to a displaced server. The server determines the user's demographics from a first database and the content segments from a second database. The server selects advertisements from a third database based upon the user's demographics and the content segments. The content segments and the advertisements are transmitted to the user for viewing. Alternatively, the user's global positioning are determined and advertisements are selected and transmitted to the user in accordance with the positioning and demographics. Further, the advertisements may be selected on the basis of artificial intelligence in the form of the user's behavioral model algorithms. Additionally, a priority may be established among users by determining if each user's demographics match pre-selected factors and by providing user priority on the basis of the number of matched factors for each user.

### CROSS-REFERENCES TO RELATED APPLICATIONS

This invention relates to systems for, and methods of, obtaining a selection by a user of specified content, segments of a visual presentation (e.g., movie) and of disposing advertisements between the specific content segments. The advertisements are based upon the demographic characteristics of the user and also upon the specific contents selected by the user. The invention also relates to a system for, and a method of, selecting advertisements dependent upon the global positioning and demographics of the user. The invention additionally relates to a system for, and method of, selecting advertisements based upon the behavioral characteristics or artificial intelligence of the user.

### BACKGROUND OF THE INVENTION

Television programs generally have a duration of one-half of an hour (½ hr.) or one hour (1 hr.). Advertisements are presented at spaced times intervals during the presentations. The advertisements are presented on a mass market basis to appeal to a large segment of the population. An attempt has been made, on the basis of studies, to relate the advertisements on a general basis to the television program being selected.

It would be desirable to relate the advertisement to the presentation on a more individualistic basis than in the prior art. For example, it would be desirable to select an advertisement for presentation to a user on the basis of the demographics of the user. It would also be desirable to select the advertisements for presentation to the user on the basis of the characteristics of the presentation that is selected by the user. It would further be desirable to select the advertisements for presentation to the user on the basis of the global positioning of the user. For example, if the global positioning of the user is near a McDonald's establishment and the demographics establish that the user has a fondness for McDonald's hamburgers, it would be desirable to present the McDonald's establishment as one of the advertisers.

The selection of the advertisements for presentation to the user on the basis of the criteria specified in the previous paragraph would enhance the effectiveness of the advertisements with respect to the user. For example, the selection of the advertisements on the basis of the demographics of the user (e.g., the user's age, the user's income, the user's education and the user's likes and dislikes) would enhance the user's positive response to the advertisements. Furthermore, the selection of the advertisements on the basis of the user's global positioning would also enhance the user's positive response to the advertisements.

### BRIEF DESCRIPTION OF A PREFERRED EMBODIMENT OF THE INVENTION

A user elects to view specific content segments (e.g., movie). The user transmits this election and his identity to a displaced server. The server determines the user's demographics from a first database and the content segments from a second database. The server selects advertisements from a third database based upon the user's demographics and the content segments. The content segments and the advertisements are transmitted to the user for viewing. Alternatively, the user's global positioning are determined and advertisements are selected and transmitted to the user in accordance with the positioning and demographics. Further, the advertisements may be selected on the basis of artificial intelligence in the form of the user's behavioral model algorithms. Additionally, a priority may be established among users by determining if each user's demographics match pre-selected factors and by providing user priority on the basis of the number of matched factors for each user.

### BRIEF DESCRIPTION OF THE DRAWINGS

In the drawings:

FIG. 1 is a flow chart schematically showing the operation of one embodiment of the invention for matching the content segments (e.g., movie) selected by a user with the demographic characteristics and the global positioning of the user to provide a visual display to the user of the content segments (e.g., movie) separated by advertisements appropriate to the user in accordance with the demographic characteristics of the user and the global positioning of the user;

FIG. 2 is a flow chart indicating the construction and operation of a second embodiment of the invention in which a plurality of users are provided and in which visual displays of content segments selected by each of the users are provided for visual display and in which priorities are established among the users on the basis of demographic factors among the users;

FIGS. 3 and 4 are flow charts indicating how behavioral information of a user controls suggestions that may be made to the user for providing items of possible interest to the user.

### DETAILED DESCRIPTION OF PREFERRED EMBODIMENTS OF THE INVENTION

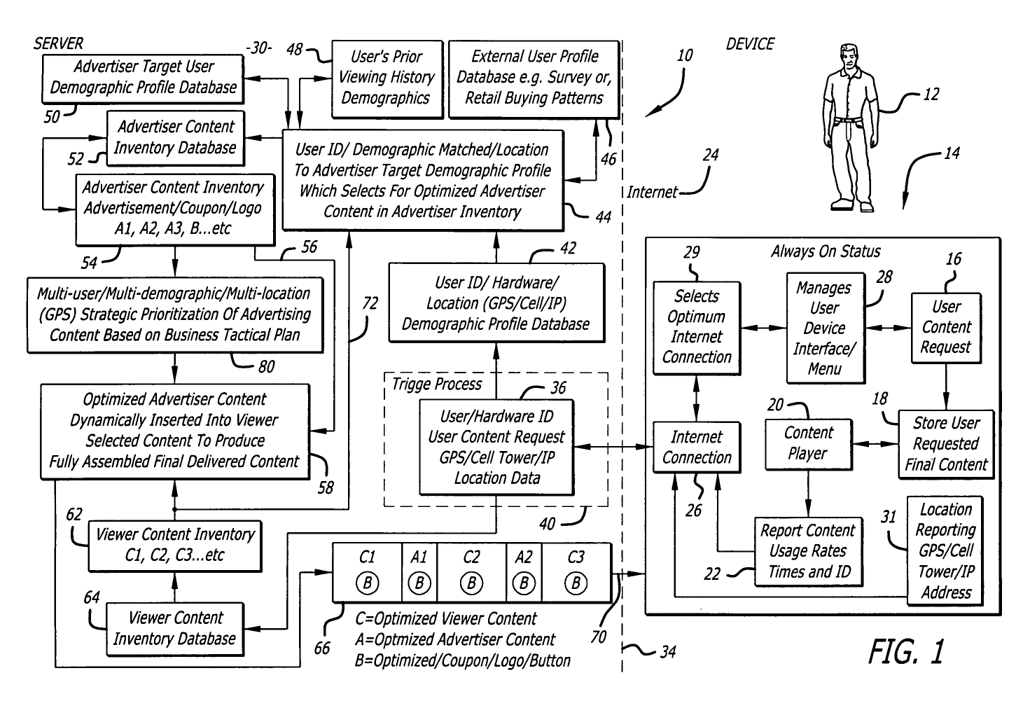

In one embodiment of the invention, generally indicated at 10 in FIG. 1, a system is provided for displaying to a user 12 segments of contents (e.g., movies and other visual presentations and advertisements between the successive visual segments. The advertisements may have characteristics related to the demographic characteristics of the user. For example, advertisements displayed to a male, 20 years old and not married, will probably be quite different from advertisements displayed to a married woman 50 years old and with two (2) teenaged children.

The system 10 includes apparatus generally indicated at 14 for viewing the content segments. The viewing apparatus is located at a position convenient to the user. The operation of the apparatus 14 is initiated when the user makes a request 16 to see particular contents (e.g., the movie “Gone With The Wind”). This request is processed and stored as at 18 and the processed and stored information is introduced to a content player 20 such as a television set. The processed and stored contents information may be in the form of timed segments similar to what is provided now in television when a movie such as “Gone With The Wind” is presented in successive segments.

The timed contents are introduced to a content player 20 such as a commonly used television set. The timed contents are introduced to a stage 22 which operates to report the content usage rates. The access to the internet 24 is provided through an internet connection 26. The internet connection 26 is well known in the art. A storage 28 manages the operation of the user device such as the television set. A stage 29 selects the optimum internet connection and introduces this information to the internet connection 26. A global positioning system 31 determines the global positioning of the user 12 and introduces this information to the internet connection 26. The global positioning system 31 is well-known in the art.

The content segment request by the user 12 is also introduced from the stage 16 to a stage 28. The stage 28 manages the television receiver and provides an interface to the internet connection 24. A stage 29 selects the optimum connection to the internet 24. In this way, the signals indicating in the stage 22 the selected contents (e.g., the movie “Gone With The Wind”) and signals indicating the global position of the user pass through in the internet 24.

The status of the system 10 is that it is always energized and that it is always ready to receive content selections from the user 12. The signals generated by the system 10 are transmitted through the internet 24 to a system generally indicated at 30 in FIG. 1. The system 30 is displaced from the system 14 and the transmission between the systems 14 and 30 may be wireless. The system 30 is always energized so that it can receive and process the signal from the system 14. A firewall 34 indicated by vertically disposed broken lines 34 in FIG. 1 is disposed between the system 14 and the system 30 to prevent signals from leaking between the systems 14 and 30.

The signals from the system 14 are received in a triage stage 36 in the system 14. The triage stage 36 may actually constitute several stages which may be independent from each other. The triage stage 30 may identify the user 12 from the information transmitted by the system 14 to the system 30. The stage 36 may also receive and process the global positioning signals identifying the location of the user 12. The stage 36 may additionally receive and process the request of the user 12 to select the content segments. A firewall 40 may be disposed around the triage process to prevent leakage between the triage process and the internet 24.

The signals from the triage stage 36 pass to a stage 42 which performs several different functions. The stage 42 may accordingly be divided into several different stages. One stage identifies the user 12 and passes this identity to a demographic database. The demographic database provides demographic information concerning a plurality of individuals, one of whom may be the user 12. The demographic information relating to the user 12 may include the user's age, sex, marital status, number of children, present and prior addresses, memberships in organizations including political parties, employment history, positions at the user's different employers, autos purchased and financing histories. The information at the stage 42 may also include the global positioning of the user 12.

Signals from the stage 42 pass to a stage 44 which provides for the selection of an optimized advertiser content in an advertiser inventory. The stage 44 uses the identity of the user 12 to determine the optimized advertiser content. The stage 44 then selects the optimized advertiser content from a database of advertising content. The selection is on the basis of the demographic profile from the file of the user. Alternatively, the stage 44 selects the optimized advertising content on the basis of the global positioning of the user 12. As a further alternative, the stage 44 selects the optimized advertising content on the basis of a combination of the global positioning of the user and the demographic profile of the user. For example, the selection may be made initially on the basis of the demographic characteristics of the user and the selected advertising concept may then be limited to the global positioning of the user.

The selection of the optimized advertiser content may be revised in certain illustrative ways. For example, the demographic characteristics of the user may be modified to include an external user profile database. This database may include a survey of the retail buying patterns of the user, for a specified period of time. As another example, demographics may be provided at the stage 48 of the user's prior viewing history of content (e.g., movies) for a specified period of time. The demographic information provided by the stages 46 and 48 sharpens the selection by the stage 44 of the optimized advertiser content that will be provided in the time slots between the successive contents (e.g., movie segments).

The stage 44 also communicates with a stage 50 so that communications pass from the stage 44 to the stage 50 and from the stage 50 to the stage 44. The stage 50 provides a database of demographic profiles of the user for advertiser targets. In other words, the stage 50 provides a demographic profile of advertisements that the stage 44 may select in accordance with the demographic profile provided by the stage 44 of the user 12.

The advertisements selected by the stage 44 are introduced to a stage 52 to provide a database of the selected advertiser content inventory. The advertiser content inventory in the database 52 is introduced to stage 54 providing a sequence of optimized advertisements A1, A2, A3, etc. Each of the advertisements A1, A2, A3, etc is disposed between a successive pair of content segments. In other words, the advertisement A1 may be disposed between the content segments 1 and 2 of the movie “Gone With The Wind” and the advertisement A2 may be disposed between the content segments 2 and 3 of the movie “Gone With The Wind.”

The stage 54 also may provide a plurality of optimized coupons, logos or buttons, all indicated on a general basis by the letter B. The sequence A1, A2, A3, etc., of advertisements may be provided at the same time as the sequence B of optimized coupons or buttons. When this occurs, the coupons, logos and buttons B may be displaced on the displayed image from the advertisements A1, A2, A3, etc. When only a single user is involved, the advertisement signals A1, A2, A3, B, etc. may pass through lines 56 from the stage 54 to a stage 58.

A stage 60 may receive the signals from the stage 54. The stage 60 indicates that the system simultaneously processes the content segment selections from a multiple number of users, including users with individual demographic characteristics and with individual global positionings. The information relating to each of the multiple users receives a strategic prioritization of advertisements in accordance with the individual demographic characteristics of each user and the global positioning of the user. The strategic prioritization of advertising content for each user may be based upon a business tactical play for each of the multiple number of users. This will be explained in additional detail subsequently in connection with the embodiments shown in FIG. 1.

In addition to receiving the signals in the stages 56 and 60, the stage 58 also receives the signals from a stage 62 providing the user with a content inventory. These may illustratively constitute successive segments C1, C2, C3, etc. of a movie such as “Gone With The Wind.” The user content inventory C1, C2, C3, etc. may be obtained from user contents inventory database 64. The user content inventory C1, C2, C3, etc. is obtained from the triage Processor 36 in accordance with the User Content Request in the triage Processor 36.

The signals from the stage 58 pass to what may be considered to be the input of a delay line 66. The delay line 66 may be considered to be formed from a plurality of successive segments 66a, 66b, 66c, etc. These segments are successively indicated as C1, A1, C2, A2, C3, A3, etc. where the segments C1, C2, C3, etc. indicate successive content segments (e.g., of the movie Gone With The Wind); the segments A1, A2, A3, etc. indicate successive advertising segments; and the optimized coupons, logos and buttons are indicated by the letter B. As will be seen in the embodiments shown in FIG. 1, the optimized coupons, logos and buttons are provided in every one of the content segments and advertisement segments. This is only one of a number of ways to optimize coupons, logos and segments. For example, the coupons, logos and buttons may be provided only in the content segments or only in the advertisements segments or in both the content segments and the advertisements or only in individual one of the content segments and the advertisements. The output end of the delay line 66 may be connected by a cable 70 to the stage 14 to provide a display on a television screen. In this way, the user may see successive content segments (e.g., Gone With The Wind) selected by the user interspersed with advertisements that are of particular interest to the user.

A cable 72 may be connected between the stage 62 and the stage 44. The cable 72 provides for the introduction to the stage 44 of the viewer content inventory in the stage 62. This content inventory may constitute one of the factors for determining the advertisements that are selected from the advertisements inventory database 52 for use in the advertisements that are presented to the user 12 for display in the time slots between successive content segments. For example, when the selected time slots relate to sport content such as a basketball game, the advertisements may relate to basketball wearing apparel such as basketball shirts with the name and number of one of the star players on the backs of the shirts.

The user 12 selects content segments and transmits the selections through the internet 24 to the content segment inventory database 64 in the server 30. The user also identifies himself or herself and sends the identification through the internet 24 to the server 30. The database 42 in the server 30 identifies the user 12 and obtains the demographics of the user from the database. The server 30 also determines the global positioning of the user in the stage 62. The stage 60 then selects the advertisements from the database 52 on the basis of individual ones or all of the user's demographic, the global positioning of the user and the selected content segments. The stage 58 then mixes or interleaves the selected content segments and the selected advertisements. For example, the mixing or interleaving may involve an alternate arrangement of successive ones of the content segments and successive ones of the advertisements as indicated at 66. The alternate arrangement of the selected content segments and the selected advertisements is transmitted through the internet 24 to the viewing apparatus 14 for viewing by the user 12.

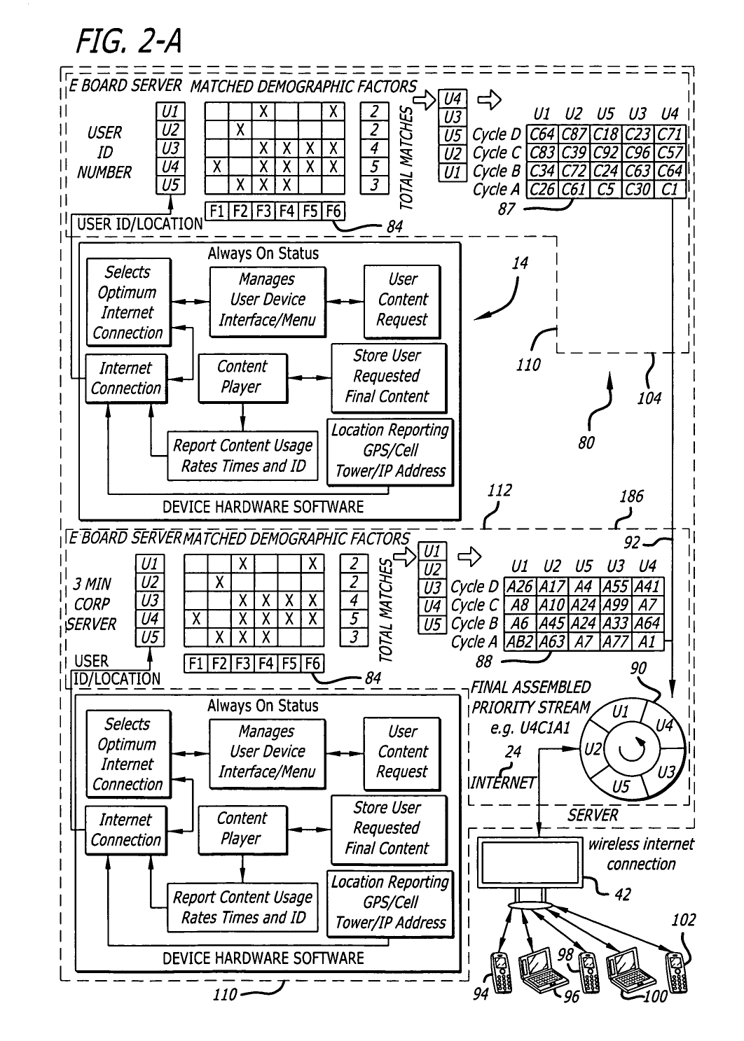

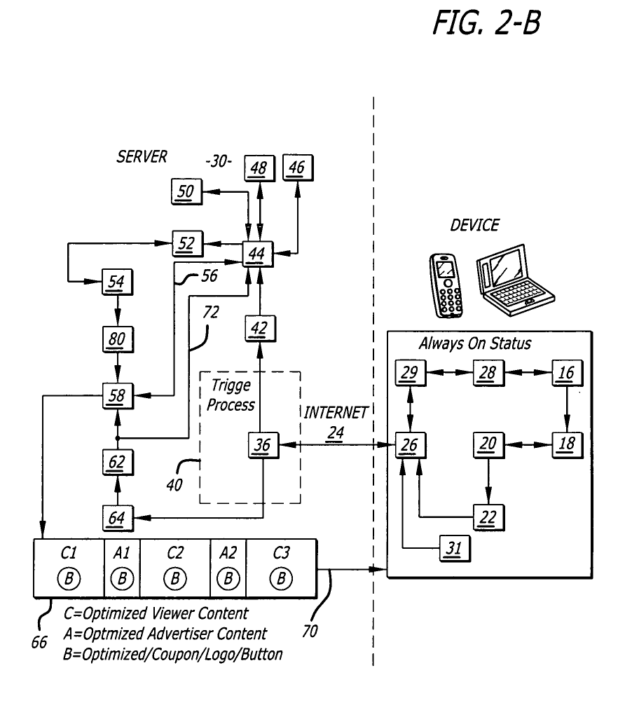

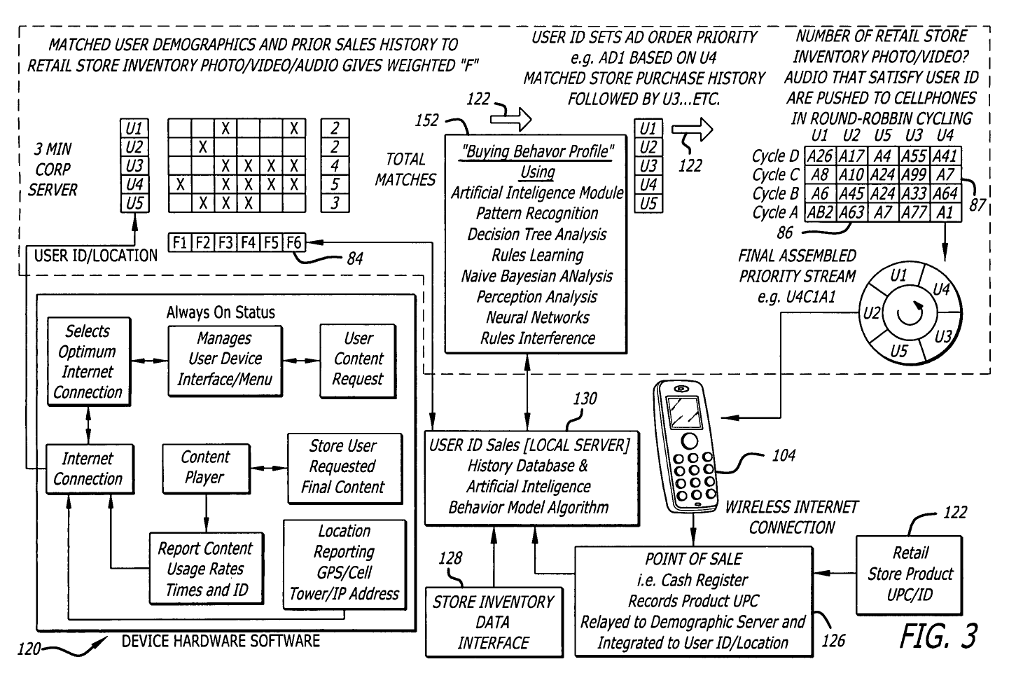

FIG. 2 includes the server 30 also shown in FIG. 1 and described above. The server 30 in FIG. 3 includes the same arrangement of stages as the server 30 in FIG. 1. the server 30 transmits a mixture of content segments and advertisements to the system 14 also shown in FIG. 1. The system 14 in FIG. 2 includes the same arrangement of stages as the system 14 shown in FIG. 1. These steps provide for a visual display to the user 12 of the content segments and advertisements provided by the server 30.

FIG. 2 shows a system, generally indicated at 80, for simultaneously processing requests for content segments from a plurality of users U1, U2, U3, U4 and U5 to provide content segment displays requested by the users and to provide to each of the users advertisements compatible with the demographic characteristics of the users and compatible with the requests for content segments from the user. The system 80 includes the server 30 for determining the content segments and advertisements of each of the users and for transmitting the content segment selection through an internet 82 to the server 30 for providing the selected content segments for each of the users U1-U5 and for providing appropriate advertisements for display between the content segments for each of the users.

FIG. 2 includes a chart 84 in which a plurality of demographic factors F1-F6 are disposed along the horizontal axis and in which the users U1, U2, U3, U4 and U5 are disposed along the vertical axis. The demographic factors F1-F6 along the horizontal axis for each of the user U1-U5 may be any selected ones of a plurality of factors. For example, the demographic factors may include sex and marital status, university degree and employment. An “X” in a box in the first column may indicate a male and a blank in the box may indicate a female. In like manner, an “X” in a box in the second column may indicate that the user is married and a blank in the box may indicate that the user is not married. Similar criteria may be established for the demographic factors F1-F6.

The chart 84 provides an indication of six (6) different demographic factors. As will be seen, the user U5 provides an X¹¹ indication for five (5) of the six (6) demographic factors F1-F6; the user U4 provides a positive indication X for four (4) of the demographic factors; the user U3 provides an indication of X for three (3) of the demographic factors; and the users U2 and U1 provide an indication of X for two (2) of the demographic factors. The users may accordingly be processed in a sequence of U5, U4, U3, U2 and U1 in accordance with the number of demographic factors indicated by an X for each of the users. It will be appreciated that any other sequence of users than the sequence U5, U4, U3, U2 and U1 can be chosen and that the demographic factors for the users can be varied without departing from the scope of the invention.

Two additional charts are shown in FIG. 2 and are respectively indicated at 87 and 88. The chart 87 indicates the selected content segments C for each of the users U1-U5. For example, the successive content segments for the user U4 in successive cycles A, B, C and D may be indicated as C1, C64, C57 and C71. The content segments C1, C64, C57 and C71 are indicative of positions in the content segment database 64 in FIGS. 1 and 2. In like manner, the database positions in the content segment database 64 in FIGS. 1 and 2 are indicated at C5, C24, C92 and C15 in the chart 86 for the user U5.

In like manner, the chart 88 indicates the positions of the successive advertisements in the advertisement database 52 in FIGS. 1 and 2. For example, the advertisements selected for the user U4 in successive are indicated at A1, A64, A7 and A41. In like manner, the successive advertisements in the advertisement database for the user U5 are indicated at A7, A24, A24 and A4.

The selected content segments in the chart 87 and the selected advertisements in the chart 88 are introduced to a rotary member 90 as indicated schematically by a line 92 in FIG. 2. Initially, one of the content segments is introduced to the rotary member 90 and then one of the advertisements is introduced to the rotary member. As indicated in the charts 87 and 88, the first content segment in the chart 87 may be that designated as C1 in the database 64 in FIG. 1 and then the first advertisement may be A1. The second content segment introduced to the rotary member 90 may be C30 in the chart 87 and the second advertisement may be A77 in the chart 88. In this way, content segments may be successively introduced in a first cycle from the database 64 for the users U5, U4, U3, U2 and U1 and advertisements may be successively introduced in the first cycle from the database 52 for the users U5, U4, U3, U2 and U1. As will be seen, the content segments may alternate with the advertisements. However, any number of different interleaved or mixed relationships may be provided between the different content segments and the different advertisements without departing from the scope of the invention.

As shown in the charts 87 and 88 in FIG. 2, the content segments and the advertisements preferably are alternately introduced to the rotary member 90 for the different users in a first cycle A. This is repeated again for subsequent cycles B, C and D to alternately display content segments and advertisements to the users.

The cycles introduced to the rotary member 90 are directed to the viewing apparatus 14 in FIGS. 1 and 2. This may occur on a wired or a wireless basis. The selected content segments and the advertisements for the user U1 may then be directed to a cell phone or a personal digital assistant (PDA) 94. In like manner, the content segments and advertisements for the user U2 may be directed to a cell phone or PDA 96. Cell phones or PDAs 98, 101 and 102 may also be respectively provided for the users U3, U4 and U5 to display selected content segments and selected advertisements to the users U3, U4 and U5.

Firewalls 106 and 108 are provided in FIG. 2. The firewalls 106 and 108 are represented by dark broken lines. The firewall 106 is disposed around the charts 84 and 87 which indicate the content segments C for the users U1-U5. The firewall 108 is disposed around the charts 86 and 88 which indicate the advertisements A between the content segments for each of the users U1-U5. The firewalls 106 and 108 isolate the content segments C electrically from the advertisements A. A firewall 110 is disposed around the structure individual to FIG. 2 to isolate this structure electrically from the server 30 and the system 14.

The user 12 selects content segments and transmits the selections through the internet 24 to the content inventory database 64 in the server 30. The selections also identifies himself or herself and sends the identification through the internet 24 to the server 30. The database 42 in the server 30 identifies the user 12 and obtains the demographics of the user from the database. The server 30 also determines the global positioning of the user in the stage 31. The stage 60 then selects the advertisements from the database 52 on the basis of individual ones or all of the user's demographics, the global positioning of the user and the selected content segments. The stage 58 then mixes the selected content segments and the selected advertisements. For example, the mixing may involve an alternate arrangement of successive ones of the content segments and successive ones of the advertisements as indicated at 66. The alternate arrangement of the selected content segments and the selected advertisements are transmitted through the internet 24 to the viewing apparatus 14 for viewing by the user 12.

FIG. 3 shows a system, generally indicated at 120, which is modified from the systems shown in FIGS. 1 and 2 to provide for artificial intelligence (or behavioral patterns) in purchases by the user 12. FIG. 3 includes the chart 84 for indicating the existence of specified demographic factors in each of the users U1-U5. As indicated by arrows 122, the results pass to the chart 87 which provides for an introduction of the content segments through the rotary member 90 in FIG. 2 to the users U1-U5. The display of the content segments and the advertisements such as at U4 C1 A1 is provided to the users U1-U5 on a cyclic basis. The user U4 is shown by way of illustration in FIG. 3.

The system shown in FIG. 3 also includes a box 122 for providing an output whenever a product in a particular store is sold. The sale is recorded in a point-of-sale register as indicated at 126 in FIG. 3. This sale is recorded in a Universal Price Code (UPC) (see boxes 122 and 126) which is well-known in the art. The sale is relayed to the demographic server which is also shown in FIG. 1. The sale is also integrated to the user identification (ID) location (see 126).

The sale is also introduced to a database 128 which stores current data concerning the inventory in the store. Information is transferred back and forth between the store inventory database 128 and a local server 130 which provides a database constituting a history of the sales by the store to the user.

There are two-way communications between the point-of-sale register 126 and the inventory data storage 128 and between the database storage 128 and a local server 130. The local server 130 provides a sales history database and stores information concerning purchases made by the user (e.g., U4. The data stored in the local server 130 may included items purchased, the date of the purchases and the price of the purchases. The data stored may even include information concerning a correlation between the items purchased and the advertisements to the user at the time of the purchase. The data stored in the local server 130 may provide a basis for artificial intelligence provided to the user in the nature of recommendations to the user for different items that may be of interest to the user for possible purchase. The artificial intelligence may be in the form of a behavioral model algorithm.

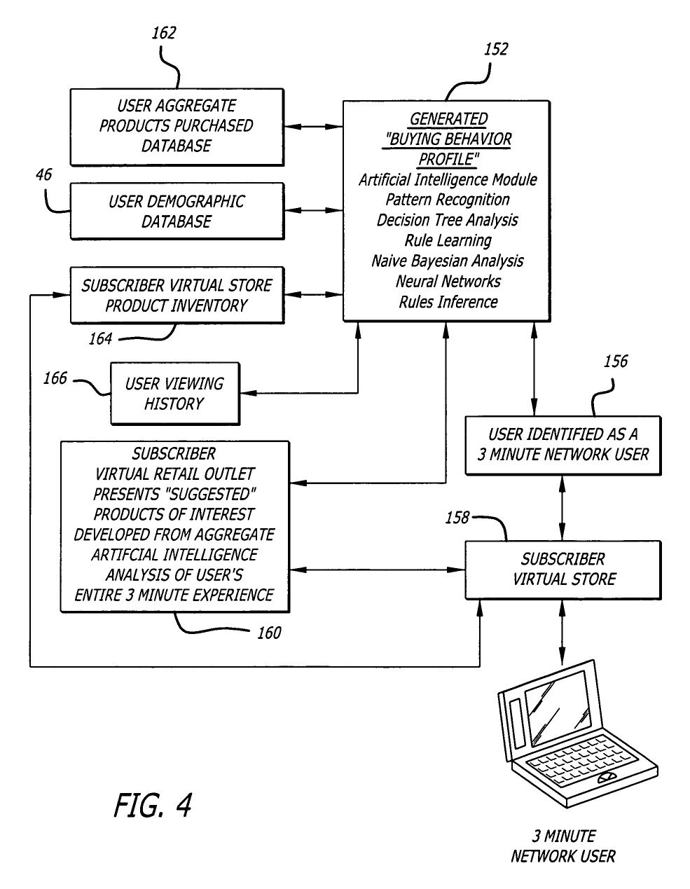

There are different approaches to artificial intelligence. They are shown in an artificial intelligence model 152 in FIG. 4. The different approaches include (a) pattern recognition, (b) rules learning, (c) decision tree analysis, (d) naive bayesian analysis, (e) perception analysis, (neutral networks and (g) rules inference. All of these are well-known in the art.

The network 152 communicates with a user (among 12 and U1-U5) identified as a 3-minute network user 156. A 3-minute user sees a selected content segments for 3 minutes and then sees an advertisement that is selected demographically or behaviorally. The demographic selection is shown in FIGS. 1-3 and has been described previously. The behavioral selection is shown in FIG. 4 and has been described previously in connection with FIG. 3 and will now be described in additional detail in connection with FIG. 4.

Communication is provided between the 3-minute network user 156 and a subscriber virtual store 158. The subscriber virtual store 158 provides inventory that may be suggested to the user on the basis of the behavioral patterns developed for the user from information previously developed by the user. The subscriber in the subscriber virtual store 158 receives behavioral information (i.e., artificial intelligence) from a subscriber virtual retail outlet 160. The outlet 160 presents “suggested” products that are of interest to the user. These products of interest have been developed from aggregate artificial intelligence analyses of the user's entire 3-minute experiences. The suggested products of interest are introduced to the subscriber virtual store 158. The virtual store 158 then introduces the suggested product of interest to the user's display module on the basis that the product is something of special interest to the user for purchase by the user.

The suggested products of interest to the user are determined on the basis of a combination of different factors, all of which provide an interrelationship between these factors and the module 152. One of these factors is provided by a database 162 of the aggregate of the products purchased by the user. These may constitute all products purchased by the user and not just the products purchased by the user as a result of the advertisements between the successive 3-minute product segments. Furthermore, if the virtual retail outlet is a part of a chain of stores and/or outlets, the products purchased by the user constitute a composite or aggregate of all of the purchases by the user from all of the different stores and outlets.

The suggested products of interest to the user are also determined on the basis of the user demographic database 46. Communications are provided between the user demographic database 46 and the artificial intelligence module 152 to provide the information from the database to the intelligence module.

The product inventory 164 in the subscriber virtual store is also provided to the artificial intelligence module 152. The user viewing history 166 is also provided to the artificial intelligence module 152 as a part of the information which the module uses to determine the artificial intelligence information which is provided to the user.

Although this invention has been disclosed and illustrated with reference to particular preferred embodiments, the principles involved are susceptible for use in numerous other embodiments which will be apparent to persons of ordinary skill in the art. The invention is, therefore, to be limited only as indicated by the scope of the appended claims.

We claim:

1. In a method of providing user content and advertising content to a viewer, the steps of:
providing the identity of the user,
providing a first database of content segments,
determining the demographic characteristics of the user from the identity of the user;
providing for a selection by the user of particular ones of the content segments in the first database;
providing a second database of different types of advertisements;
selecting individual ones of the advertisements in accordance with the demographic characteristics of the user, and
providing for the viewing by the user of the selected ones of the content segments and the selected advertisements in an interleaved relationship of the content segments and the advertisement.

2. In a method as set forth in claim 1, including the steps of
providing for the selection by the user of content segments to be viewed by the user wherein
the selected ones of the advertisements are provided in a sequence and wherein
successive ones of the advertisements in the sequence are disposed between successive ones of the content segments for viewing by the user.

3. In a method as set forth in claim 2 wherein
the advertisements are selected in accordance with the demographic characteristics of the user.

4. In a method as set forth in claim 3 wherein
the global position of the user is detected and wherein
the advertisements to be viewed by the user are also selected on the basis of the global positioning of the user at the time of the selection and wherein the content segments are provided from the first database at the same rate that the advertisements are provided from the second database.

5. A method as set forth in claim 2 wherein
the advertisements are selected in accordance with the demographic characteristics of the user and wherein
the advertisements to be viewed by the user are also selected on the basis of the global positioning of the user at the time of the selection and wherein the content segments are provided from the first database at the same rate that the advertisements are provided from the second database.

6. In a method of providing content and advertisements to a user, including the steps of:
determining the demographic characteristics of the user,
determining the global positioning of the user,
providing a first database of different advertisements,
selecting from the first database individual advertisements in accordance with the global positioning of the user and the demographic characteristics of the user,
providing a second database of content segments,
providing for a selection by the user of content segments in the second database, and
providing for an interspersed display to the user of the selected content segments from the second database and the selected advertisements from the first database.

7. In a method as set forth in claim 6, the steps of
selecting from the first database a sequence of advertisements in accordance with the demographic characteristics of the user, and
selecting from the second database a sequence of content segments,
providing the sequence of the selected advertisements to the user for interspersed display with the sequence of the content segments.

8. In a method as set forth in claim 7 wherein
the selected advertisements are disposed in a sequence alternating with successive content segments selected by the user.

9. In a method as set forth in claim 8 wherein
the sequence of advertisements is also selected in accordance with the sequence of content segments selected by the user.

10. In a method of providing content segments and advertisements to a user, the steps of:
providing a request by the user for a display of a selected user content having particular characteristics,
providing an identification of the user,
passing the user content request to a server displaced from the user,
providing at the server the user content request and the user identification to a demographic database to select at the demographic database an advertiser content inventory compatible with the demographic database of the user,
inserting at the server the selected advertiser content inventory into the user selected content to produce an interleaved sequence of the selected user content and the selected advertiser content inventory, and
passing the interleaved sequence at the server to the user for display to the user.

11. In a method as set forth in claim 10 wherein
the global positioning of the user is determined and wherein
the advertisements are selected in accordance with the global positioning determined for the user and wherein
the advertisements selected in accordance with the global positioning determined for the user are interleaved with the user's selected content to produce an interleaved relationship of the user's selected content and the selected advertisements.

12. In a method as set forth in claim 10 wherein
a firewall is provided between the user and the server.

13. In a method as set forth in claim 10 wherein
the user content in the sequence is alternated at the server with the advertisements in the sequence.

14. In a method as set forth in claim 11 wherein
a firewall is provided between the user and the server and wherein
the user content in the sequence is alternated at the server with the advertisements in the sequence.

15. In a method of providing content and advertising to a user,
providing at the user an identification of the user,
providing at the user a global positioning of the user,
transmitting the identification and the global positioning of the user to a server displaced from the user,
providing at the server a first database providing demographics of a plurality of individuals,
selecting the demographics of the user at the server from the database on the basis of the identification of the user,
providing a second database of advertisements of commercial establishments in the vicinity of the user's global positioning,
selecting advertisements from the second database in accordance with the global positioning and demographics of the user, and
transmitting the selected advertisements to the user.

16. In a method as set forth in claim 15, the step of:
providing a firewall between the user and the server to separate the operation of the user from the operation of the server.

17. In a method as set forth in claim 15, the step of:
electronically transmitting the identity of the user to the server, and
electronically transmitting the selected advertisements to the user from the server.

18. The In a method of providing viewer content and advertiser content to a user, the steps of
requesting at a user successive segments of viewer content having particular characteristics,
electronically passing to a server the identification of the user and the request by the user for the viewing of the viewer content having the particular characteristics,
determining the demographic profile of the user from information previously provided relating to the user and from the user identification,
matching at the server the demographic content of the user to advertisements at the server to obtain advertiser content consistent with the viewer content having the particular characteristics,
dynamically matching at the server the advertising content to the segments of the viewer content having the particular characteristics, and
electronically matching the segments of the viewer content having the particular characteristics with the advertising content and passing the matched content segments and the advertisements to the user for viewing by the user.

19. In a method as set forth in claim 18,
electronically transmitting the identity of the user to the server, and
electronically transmitting the segments of the viewer content having the particular characteristics with the selected advertisements to the user from the server.

20. In a method of providing content segments and advertising to a user, including the steps of
providing at the user an identification of the user and a selection by the user of the content segments to be provided to the user,
transmitting the user identification and the selection of the content segments to a server displaced from the user,
determining the demographics of the user at the server from the identification of the user,
providing a database of advertisements at the server,
providing at the server content segments on the basis of the selection by the user,
selecting advertisements at the server in accordance with the content segments selected at the user and the demographics determined of the user at the server,
combining at the server the content segments selected at the server and the advertisements selected at the server, and
transmitting to the user the content segments selected at the user and the advertisements selected for display at the user.

21. In a method as set forth in claim 20 wherein
the contents selected at the user constitute a sequence of time-related contents and wherein
the advertisements are in a sequence related to the sequence of the time-related contents and wherein
the contents in the time-related sequence are interspersed with the advertisements in the selected advertisement sequence.

22. In a method as set forth in claim 20 wherein
the advertisements are selected at the server in accordance with the characteristics of the contents selected at the user and the demographics of the user.

23. In a method as set forth in claim 20 wherein
the contents are disposed in a database at the server and wherein
the contents are selected in the database in accordance with instructions by the user.

24. In a method as set forth in claim 20 wherein
the contents selected at the user and the advertisements selected at the server are displayed on a display member at the user.

25. In a method of providing content segments and advertisements to a user, including the steps of
providing at the user an identification of the user and a selection by the user of the content segments to be provided to the user,
transmitting the user identification and the selection of the content segments to a server displaced from the user,
determining the demographics of the user at the server,
providing a database of advertisements at the server,
providing at the server content segments on the basis of the selection by the user,
selecting advertisements at the server in accordance with the content segments selected at the user and the demographics determined of the user at the server,
combining at the server the content segments selected at the user and the selected advertisements at the server, and
transmitting to the user the content segments selected at the user with the advertisements selected for display at the user being disposed between selected content segments.

26. In a method as set forth in claim 25,
the content segments selected at the user constituting a sequence of time-related content segments and wherein
the advertisements are in a sequence related to the sequence of the time-related contents and wherein
the contents in the time-related sequence are disposed between advertisements in the selected advertisement sequence and wherein
the advertisements are selected at the server in accordance with the characteristics of the content segments selected at the user and the demographics of the user.

27. In a method of providing content segments and advertisements to a user, the steps of:
providing a first database of advertisements at a server displaced from the user,
providing at the user a second database of users and demographics of the user,
providing the identity of the user,
transmitting the identity of the user to the database of users at the server to obtain the demographics of the user,
determining the global positioning of the user,
determining the demographics of the user from the second database of the user at the server,
selecting advertisements from the first database at the server in accordance with the demographics determined at the server of the user and in accordance with the global positioning of the user, and
transmitting the content segments and the selected advertisements to the user for processing by the user.

28. In a method as set forth in claim 27, including the step of:
displaying the content segments and the selected advertisements at the user where the selected advertisements are disposed between content segments.

29. In a method as set forth in claim 27 wherein
the displayed advertisements include advertisements located in the vicinity of the global positioning of the user and compatible with the demographic characteristics of the user.

30. In a method as set forth in claim 27, wherein
the displayed advertisements are compatible with the content segments.

31. In a method of providing content segments and advertisements to a user,
providing a first database of advertisements at a server displaced from the user,
providing the identity of the user,
determining the global positioning of the user,
providing a second database at the server of the identity of the user and the demographics of the user,
determining the demographics of the user at the second database,
providing a third database of content segments,
providing for the selection by the user of content segments from the third database, and
providing for the selection by the server from the second database of advertisements compatible with the demographics of the user, the global positioning the of the user and the content segments selected by the user.

32. In a method of providing content segments and advertisements to a user, the steps of:
providing a first database of advertisements at a server displaced from the user,
providing at the server a second database of users and demographics of the users,
providing the identity of the user,
transmitting the identity of the user to the second database of users at the server to obtain the demographics of the user,
determining the global positioning of the user,
selecting advertisements from the database at the server in accordance with the demographics determined at the server of the user and in accordance with the global positioning of the user, and
transmitting the content segments and the selected advertisements to the user, in an order constituting a mixture of the content segments and the advertisements, for processing by the user.

33. In a method as set forth in claim 32,
disposing the advertisements between the content segments, and
transmitting the content segments and the advertisements to the user in the disposed relationship.

34. In a method of providing content segments and advertising to a plurality of users, the steps of:
providing the identities of the users,
providing a plurality of demographic factors to be determined for each of the users,
providing for the selection of content segments for each of the users,
providing a priority for the users in accordance with the demographic factors present in the users,
providing a database of advertisements for the users,
providing advertisements from the database for each of the users in accordance with the demographic factors determined for the users, and
providing mixed presentations of the content segments and the advertisements for each of the users in a sequence for each of the users corresponding to the priorities established for the users.

35. In a method as set forth in claim 34, the steps of:
determining the global positioning of each of the users,
selecting advertisements from the database for each of the users in accordance with the global positioning determined for the user in addition to the demographics for each of the users, and
including the advertisements, selected for each of the users in accordance with the global positioning of the user and the demographics of the user, in the mixed presentations of the content segments and the advertisements for the user.

36. In a method as set forth in claim 34, the steps of:
selecting advertisements from the database for each of the users in accordance with the content segments selected for the user, and
including the advertisements, selected for each of the users in accordance with the content segments selected for the user and the demographics of the user and the global positioning of the user, in the mixed presentations of the content segments and the advertisements for the user.

37. In a method as set forth in claim 34, the steps of:
providing a plurality of displays each serving an individual one of the users,
providing a server displaced from the users and operative to select the content segments and advertisements for each of the users, and
displaying at each of the displays the content segments and advertisements provided by the server for the display.

38. In the method as set forth in claim 37, the steps of:
providing a first firewall between the displays and the server, and
providing a second firewall between the selection of the content segments for the users and the selection of the advertisements for the users.

39. In a method as set forth in claim 38, the step of:
selecting advertisements from the database for each of the users in accordance with the content segments selected for the user, and
including the advertisements, selected for each of the users in accordance with the content segments selected for the user, in the mixed presentations of the content segments and the advertisements for the user.

40. In a method as set forth in claim 39, the steps of:
providing a first firewall between the displays and the server, and
providing a second firewall between the selection of the content segments for the users and the selection of the advertisements for the users.

41. In a method of providing content segments and advertisements to a user, the steps of:
providing a request by the user for a display at the user of content segments having particular characteristics,
passing the content request and an identification of the user to a server displaced from the user,
providing a first database at the server of advertisements available to the user,
providing the content request and the user identification to a second database at the server, the second database providing demographic information concerning the user,
selecting at the server advertisements in accordance with the demographic characteristics of the user and the content segments selected by the user, and
transmitting the selected content segments and the selected advertisements to the user, in an interspersed relationship of the selected content segments and the selected advertisements, for display at the user.

42. In a method as set forth in claim 41, the steps of:
determining the global positioning of the user, and
selecting the advertisements at the server in accordance with the demographic characteristics of the user, the content segments selected by the user and the global positioning of the user.

43. In a method as set forth in claim 41, wherein
a plurality of content segments are provided at the server in accordance with selections by the user and wherein
a plurality of advertisements are selected at the server and wherein
the selected advertisements are mixed with the selected content segments for transmittal to the user.

44. In a method as set forth in claim 41, wherein
the advertisements are also selected at the server in accordance with the content segments selected by the user and wherein
the advertisements selected at the server in accordance with the selected content segments are mixed with the selected content segments and wherein
the mixed arrangement of the selected content segments and the selected advertisements are transmitted by the server to the user and wherein
the mixed arrangement of the selected content segments and the selected advertisements are displayed at the user.

45. In a method as set forth in claim 42 wherein
a plurality of content segments are selected at the and wherein
a plurality of advertisements are selected at the server and wherein
the selected advertisements are interleaved with the selected content segments for transmittal to the user for viewing by the user and wherein
the advertisements are also selected at the server in accordance with the content segments selected at the server and wherein
the selected advertisements are alternated with the selected content segments and wherein
the alternate arrangement of the selected content segments and the selected advertisements are transmitted by the server to the user and wherein
the alternate arrangement of the selected content segments and the selected advertisements are displayed at the user.

46. In a method of providing contents and advertisements to a plurality of users, the steps of
identifying the users to a server displaced from the users,
obtaining demographics of the users from a first database at the server,
determining the applicability of each of a plurality of demographic factors to each of the users,
selecting content segments for each of the users from a second database at the server in accordance with the demographic factors determined for the users,
determining the advertisements to be provided to each of the users in accordance with the demographic factors determined for the user, and
presenting to each of the users the content segments and advertisements selected for the users in an order dependent upon the applicability of the user responses to the demographic factors.

47. In a method as set forth in claim 44 wherein
the priority of each user is dependent upon the number of demographic factors to which the user has responded.

48. In a method as set forth in claim 44 wherein
a first member is disposed at the server for providing the content segments for each of the users in the order dependent upon the applicability of the user responses to the demographic factors and wherein
a second member is disposed at the server for providing the advertisements for each of the users in the same order as the content segments provided for each of the users.

49. In a method as set forth in claim 46, wherein
the content segments for each of the users are separated by particular time periods and wherein
the selected advertisements are disposed in the separations in the time periods between adjacent content segments.

50. In a method as set forth in claim 46 wherein
the content segments for each of the users are provided on a cyclic basis and wherein the advertisements for the user are provided on a cyclic basis compatible with the provisions of the content segments for the user on the cyclic basis.

51. In a method as set forth in claim 46 wherein
the content segments and advertisements for each of the users are provided on a cyclic basis for the user dependent upon the existence of the particular demographic factors for the user and wherein
the content segments and the advertisements are provided at the same rate for each of the users.

52. In a method as set forth in claim 47 wherein
a plurality of content segments are selected at the server for each of the users and wherein
a plurality of advertisements are selected at the server for each of the users and wherein
the advertisements are also selected at the server for each of the users in accordance with the content segments selected at the server for the users and wherein
the advertisements selected at the server for each of the users in accordance with the selected content segments for the user are mixed with the selected content segments for the user and wherein
the mixture of the selected content segments for each of the users and the selected advertisements for the user are transmitted by the server to the user and wherein
the mixture of the selected content segments for each of the users and the selected advertisements for the user are displayed at the user.

53. In a method as set forth in claim 46, including
identifying the users to a server displaced from the users,
obtaining demographics of the users from a first database at the server,
determining the applicability of each of a plurality of demographic factors to each of the users,
selecting content segments for each of the users from the second database at the server in accordance with the demographic factors determined for the user,
determining the advertisements to be provided to each of the users in accordance with the demographic factors determined for the user, and
presenting to each of the users the content segments and advertisements selected for the users in an order dependent upon the applicability of the user responses to the demographic factors.

54. In a method as set forth in claim 46 wherein
the priority of each of the users is dependent upon the number of demographic factors to which the user has responded and wherein
a first member is disposed at the server for providing the content segments for each of the users in the order dependent upon the applicability of the user to the demographic factors and wherein
a second member is disposed at the server for providing the advertisements for each of the users in the same order as the content segments provided for the user.

55. A method as set forth in claim 46 wherein
the advertisements selected from the database are also dependent upon the global positioning of the user.

56. In a method as set forth in claim 55 wherein
a first member is disposed at the server for providing the contents for each of the users in the order dependent upon the applicability of the user to the demographic factors and wherein
a second member is disposed at the server for providing the advertisements for each of the users in the same order as the content segments provided for the user and wherein.
the successive content segments for each of the users are separated by in time and wherein
the selected advertisements for each of the users are disposed in a time separation between the successive content segments for the user and wherein.
the content segments for each of the user are provided on a cyclic basis and wherein the advertisements for the users are provided on the cyclic basis.

57. In a method of displaying content segments and advertisements between the content, the steps of:
providing a first database of content segments,
providing for the selection by the user of particular content segments in the first database,
providing a second database of advertisements,
providing a determination of the global positioning of the user,
providing for the selection of advertisements in accordance with the global positioning of the user, and
providing for a display to the user of the content segments selected by the user and a display of the advertisements selected in accordance with the global positioning of the user and for a display at the user of selected advertisements between selected content segments.

58. In a method as set forth in claim 57, including the steps of
providing a determination of the demographic characteristics of the user on the basis of the identity of the user, and
selecting the advertisement also in accordance with the demographic characteristics of the user.

59. A method as set forth in claim 57 wherein
the user is displaced from the databases and wherein
the user communicates electronically with the databases and the databases communication electronically with the user.

60. In a method as set forth in claim 57 wherein
the first and second databases are disposed within a server and the server is displaced electronically from the user and wherein
the server communicates electronically the selection of the content segments to the user and the selection of the advertisements to the user.

61. In a method as set forth in claim 58 wherein
the user is displaced from the databases and wherein
the user communicates electronically with the databases and the databases communication electronically with the user and wherein
the first and second databases are disposed within a server and the server is displaced electronically from the user and wherein
the server communicates electronically the selection of the content segments to the user and the selected advertisements to the user.

62. In a method of displaying content segments and advertisements between the content segments, the steps of:
providing a first database of content segments at a server displaced from the user,
providing for the selection by the user of particular content segments in the first database,
providing a second database of advertisements at the server,
providing for the selection of advertisements at the server in accordance with the content segments selected by the user,
transmitting the selected content segments and the selected advertisements from the server to the user, and
providing for a display to the user of the content segments selected by the user and a display of the advertisements selected in accordance with the selected content segments.

63. In a method as set forth in claim 62, the steps of:
providing a determination of the demographic characteristics of the user on the basis of the identity of the user, and
selecting the advertisements in accordance with the demographic characteristics of the user and the content segments selected by the user and wherein
the user is displaced from the databases and wherein
the user communicates electronically with the server and the server communicates electronically with the user.

64. In a method as set forth in claim 62 wherein
the selected advertisements are mixed with the selected content segments at the server and the mixed content segments and the mixed advertisements are transmitted electronically from the server to the user.

65. In a method as set forth in claim 61 wherein
the first and second databases are disposed within a server and the server is displaced electronically from the user and wherein
the user communicates electronically the selection of the content segments to the server and the server communicates electronically the mixture of the selected content segments and the selected advertisements to the user.

66. In a method as set forth in claim 65 including the steps of:
providing a determination of the demographic characteristics of the user on the basis of the identity of the user, and
selecting the advertisements in accordance with the demographic characteristics of the user and the content segments selected by the user
the user is displaced from the databases and wherein
the user communicates electronically with the databases and the databases communicates electronically with the user.

67. In a method as set forth in claim 63, including the steps of:
providing a history of the viewing by the user of the content segments and the advertisements,
providing a third database indicating the aggregate of the products purchased by the user,
using information relating to the demographic characteristics of the user, the viewing history of the user, and the indications in the third database relating to the purchases of the user to provide artificial intelligence suggesting products of interest to the user for purchase by the user.

68. In a method as set forth in claim 62, the steps of:
identifying the user as viewer of content segments from the second database and advertisements from the first database, and
introducing the artificial intelligence to the user to suggest to the user products of interest to the user for purchase by the user.

69. In a method as set forth in claim 68 including the steps of
providing a history of the viewing by the user of the content segments and the selected advertisements,
combining the viewing history of the user and the demographic characteristics of the user to provide a behavioral indication to the user of suggested products to be purchased by the user; and
informing the user of the suggested products to be purchased by the user.

70. In a method as set forth in claim 69 wherein
the user is identified as a user of the combination of the selected content segments and the selected advertisements and wherein
the behavioral indication to the user of the products to be purchased by the user is on the basis of an artificial intelligence analysis of the user's experience in purchasing products selected by the user from the advertisements selected for display by the user.

71. In a method of providing artificial intelligence indicating products to be purchased by a user, the steps of:
providing demographic characteristics of the user from the identity of the user,
providing a history of purchases made by the user, and
predicting the behavioral characteristics of the user from the demographic characteristics of the user and the history of purchases made by the user.

72. In a method as set forth in claim 71 wherein
recommendations to the user for the purchase of products by the user are made to the user in accordance with the behavioral characteristics determined for the user.

73. In a method as set forth in claim 72 wherein
the recommendations to the user of the purchase of products is made by a seller on the basis of inventory in the seller's establishment.

74. In a method as set forth in claim 72 wherein
advertisements are provided to the user on the basis of content segments selected by the user and wherein
a determination is made as to whether the advertisements have had an effect on the purchases made by the user and wherein
the effect of the advertisement on the purchase history of the user is a factor in making recommendations by the user of products to be purchased by the user.

75. In a method of providing content segments and advertising to a user, the steps of:
providing a first database of advertisements at a server displaced form the user,
providing the identity of the user at the server,
determining the global positioning of the user,
providing a second database at the server of the identity of the user and the demographics of the user,
determining the demographics of the user at the second database,
indicating content segments selected by the user,
providing a third database of content segments,
providing for the selection by the user of content segments from the third database, and
providing for the selection by the server from the second database of advertisements compatible with the demographics of the user, the global positioning of the user and the content segments selected by the user.
